(19) United States
(12) Patent Application Publication
(10) Pub. No.: US 2017/0373385 A1
(43) Pub. Date: Dec. 28, 2017

(54) DIELECTRIC-CORE ANTENNAS SURROUNDED BY PATTERNED METALLIC METASURFACES TO REALIZE RADIO-TRANSPARENT ANTENNAS

(71) Applicant: Board of Regents, The University of Texas System, Austin, TX (US)

(72) Inventors: Andrea Alu, Austin, TX (US); Jason Soric, Austin, TX (US); Scott Michaelis, Allen, TX (US); Igor Timofeev, Richardson, TX (US); Nikolay Chistyakov, Plano, TX (US)

(21) Appl. No.: 15/524,222

(22) PCT Filed: Sep. 22, 2015
(86) PCT No.: PCT/US2015/051417

§ 371 Date: May 3, 2017

Related U.S. Application Data
(60) Provisional application No. 62/074,768, filed on Nov. 4, 2014.

(51) Int. Cl. H01Q 1/38; H01Q 15/00; H01Q 9/28; H01Q 1/42; H01Q 9/02

(52) U.S. Cl. CPC H01Q 1/38; H01Q 15/0086; H01Q 15/0013; H01Q 9/285; H01Q 9/02; H01Q 1/425; H01Q 1/422

(57) ABSTRACT

A transparent dielectric-core antenna surrounded by patterned metallic metasurfaces. The patterned metallic metasurface acts as a conductive medium for surface current to flow and efficiently radiate fields driven by a power source. Furthermore, the patterned metallic metasurface can strongly reduce the electrical presence of the dielectric-core to realize a radio-transparent antenna to nearby systems at any desired frequency band while still maintaining good radiation and matching properties. Such an antenna concept may be applied to a variety of geometries.

### CROSS REFERENCE TO RELATED APPLICATIONS

This application claims priority to U.S. Provisional Patent Application Ser. No. 62/074,768, “Dielectric-Core Antennas Surrounded by Patterned Metallic Metasurfaces to Realize Radio-Transparent Antennas,” filed Nov. 4, 2014, which is incorporated by reference herein in its entirety.

### TECHNICAL FIELD

The present invention relates generally to dipole antennas, and more particularly to utilizing metallic metasurfaces surrounding or immersed in dielectric-core structures to realize radio-transparent antennas operating over a narrow or wide frequency bandwidth.

### BACKGROUND

Conventional cylindrical dipole antennas are made from conductive rods of moderate thickness to meet bandwidth and radiation pattern requirements; however, these conductive cylindrical rods are also well known to be significant scatterers. Such strong scattering characteristics are known nuisances that may strongly affect nearby antenna systems operating in adjacent frequency bands in terms of matching and radiation characteristics.

Unfortunately, there is not currently a means for reducing the electromagnetic presence of antennas while still maintaining good radiation and matching properties.

### BRIEF SUMMARY

In one embodiment of the present invention, an antenna comprises a dielectric core covered by a patterned conductive cover, where an impedance of the patterned conductive cover is selected to reduce a scattering of the dielectric core at desired frequencies or over a desired frequency range.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1A illustrates a two-dimensional cross-section of a dielectric or magnetodielectric rod covered by a patterned metallic surface in accordance with an embodiment of the present invention;

FIG. 1B illustrates a schematic of a three-dimensional dielectric-core transparent antenna covered by a conformal strip pattern with conductive end caps in accordance with an embodiment of the present invention;

FIGS. 2A-2B illustrate the required surface impedance for dielectric rods (Dk=2.3, 4.5, respectively), where each case is compared against increasing dielectric rod diameters in accordance with an embodiment of the present invention;

FIG. 3 is the realized surface impedance map over the band of interest for values of strip width at normal incidence in accordance with an embodiment of the present invention;

FIG. 4 shows examples of the total scattering cross-section (SCS) of a baseline perfect electric conductor (PEC), the two dielectric rods, and the covered dielectric rods with d=1.5d₀ in accordance with an embodiment of the present invention;

FIG. 5 illustrates the covered LB matching and gain for the design in FIG. 1B in accordance with an embodiment of the present invention;

FIG. 6 is a proposed loaded design and improved scattering reduction tuned to the low end of the communications band for single and dual-band operation in accordance with an embodiment of the present invention;

FIG. 7A illustrates a schematic of an elliptical dielectric-core antenna in accordance with an embodiment of the present invention;

FIGS. 7B and 7C illustrates the three-dimensional SCS profiles of the bare (b) and covered (c) antennas, respectively, using the decibel scale in accordance with an embodiment of the present invention;

FIG. 8 illustrates views of a proposed planar cloaked antenna in accordance with an embodiment of the present invention;

FIG. 9 illustrates various inductive traces in accordance with an embodiment of the present invention;

FIG. 10 presents the schematic of the proposed transparent antenna cloaked with a differential helical cloak in accordance with an embodiment of the present invention;

FIG. 11A illustrates a 3D schematic of the proposed differential helix antenna with a narrowband parasitic match in accordance with an embodiment of the present invention;

FIG. 11B illustrates the total SCS comparison between the baseline dual-polarized dipole and the double helix and parasitic matching influence in accordance with an embodiment of the present invention;

FIG. 11C illustrates the gain of the double helix dielectric-core antenna at 800 MHz in accordance with an embodiment of the present invention;

FIG. 11D illustrates the gain restoration of the double helix antenna compared to a blocking cylindrical dipole at the central highband frequency in accordance with an embodiment of the present invention;

FIG. 12 illustrates the operating bands for 3G and 4G LTE service providers in accordance with an embodiment of the present invention;

FIG. 13 illustrates that a physically larger lowband (LB) antenna (698-968 MHz) is required with the highband (HB) array (1.71-2.71 GHz) in accordance with an embodiment of the present invention;

FIGS. 14A-14B show the two dual-polarized antennas above a single unit cell in accordance with an embodiment of the present invention;

FIGS. 15A-15F capture the far-field restoration across the large operating bandwidth, where FIG. 15A compares the lowband (LB) performance between the conventional cylindrical dipole (CD) and the dielectric core metasurface antenna (DCMA), and FIGS. 15B-15F are the highband (HB) panel for the isolated case, without any LB element above it in accordance with an embodiment of the present invention;

FIG. 16 illustrates the gain, bandwidth and squint versus the frequency for the cases discussed in FIGS. 15A-15F in accordance with an embodiment of the present invention;

FIG. 17A illustrates the matching of the HB elements with DCMA placed above them in accordance with an embodiment of the present invention; and

FIG. 17B illustrates the wideband matching of the DCMA antenna in the LB frequencies in accordance with an embodiment of the present invention.

### DETAILED DESCRIPTION

As stated in the Background section, conventional cylindrical dipole antennas are made from conductive rods of moderate thickness to meet bandwidth and radiation pattern requirements; however, these conductive cylindrical rods are also well known to be significant scatterers. Such strong scattering characteristics are known nuisances that may strongly affect nearby antenna systems operating in adjacent frequency bands in terms of matching and radiation characteristics. Unfortunately, there is not currently a means for reducing the electromagnetic presence of antennas while still maintaining good radiation and matching properties.

The principles of the present invention provide a means for utilizing “dielectric-core” antennas surrounded by patterned metallic metasurfaces (or “mantle surface” or “mantle cover” or “metafilm cover” or “ultrathin cover”) to realize radio-transparent antennas (i.e., without affecting nearby antenna systems operating in adjacent frequency bands) as discussed further below. In particular, the application of a mantle surface serves two distinct purposes. Firstly, the proposed mantle cover acts as a conductive medium for surface current to flow and efficiently radiate fields driven by a power source. Secondly, it is shown herein that the cloaking cover can strongly reduce the electrical presence of a dielectric-core dipole antenna to nearby systems, in principle, at any desired frequency band. Such a method may be applied to a variety of antenna geometries. Furthermore, the principles of the present invention utilize single mantle screens with large bandwidths or multi-band behavior.

Prior to the discussion of the principles of the present invention, a brief discussion of U.S. Pat. No. 4,864,314 is deemed appropriate. In U.S. Pat. No. 4,864,314, the grid microstrip low band array is located on top of a high band slotted array, and the microstrip array is transparent for signals of the slotted array. Unfortunately, both low and high band arrays are inherently narrowband (with bandwidth less than 10%) and they only work for a single polarization. Modern multiband antenna systems require a much more wideband operation, more than 40% (for example, 570-960 MHz and 1.7-2.7 GHz in wireless communications), and the solution of U.S. Pat. No. 4,864,314 cannot be applicable for them. Also, the solution presented in U.S. Pat. No. 4,864,314 is based on a radio-transparent grid with inherently limited scattering suppression over narrow bandwidths. The principles of the present invention overcome the limitations of U.S. Pat. No. 4,864,314 as discussed herein.

Transparent Antenna

Metafilm covers have been recently applied to conventional conductive rods for antenna applications. The ultrathin covers were used to strongly suppress nearby dipole radiators at all angles due to the conductive patterning on thin dielectric substrates. By using a dielectric super/substrate, the angular dependence may be reduced by a factor (∈ᵣ+1⁻¹), where ∈ᵣ, is the relative permittivity of the substrate. While the scattering suppression can be quite large, it has also been shown to be narrow, with fractional bandwidths between 1-3% for cylindrical conductive targets. Furthermore, the gain in the azimuthal plane was experimentally shown to be fully restored over large bandwidths with air-backed covers of larger aspect ratios in the presence of moderate gain antennas.

The principles of the present invention provide a new venue to realize transparent antennas, in which the cloaks themselves act as radiators, while canceling the scattering from a dielectric supporting rod. In this scenario, one can leverage ultra-low profile covers designed to cloak dielectric-rods and use them as efficient dipole radiators. The designs of the present invention can scatter over two orders of magnitude less than conventional conductive dipoles with same thickness, yet have similar radiative features.

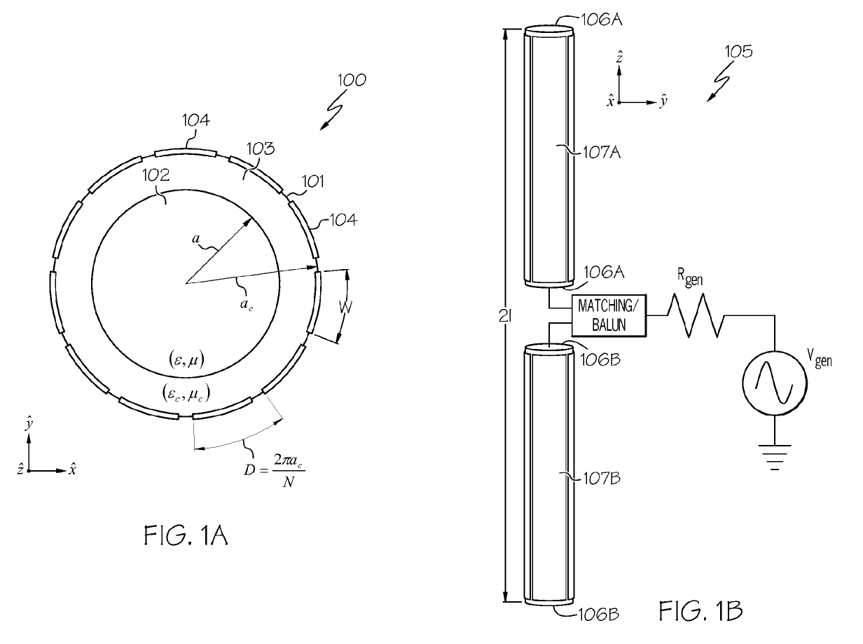

Referring to FIG. 1A, FIG. 1A illustrates a two-dimensional cross-section of a dielectric or magnetodielectric rod 100 covered by a patterned metallic surface 101 in accordance with an embodiment of the present invention. That is, FIG. 1A illustrates the cross-section of a dielectric core (∈) antenna 100 covered by an arbitrary patterned metallic cover (a mantle cloak) 101, possibly implemented with dielectric ∈_{c} substrates or superstrates. The background medium has electromagnetic parameters (∈₀, μ₀). Additionally, cover 101 itself may allow for some thickness 103 between core 102 and the conductive patterned traces 104, or cover 101 may be embedded in the dielectric itself. As a first example, conformal covers (α=α_{c}) are considered with a dielectric core. As discussed further herein, the cloaking bandwidth performance drastically improves when conformal covers are used over dielectric objects.

FIG. 1B illustrates a schematic of a three-dimensional dielectric-core transparent antenna 105 covered by a conformal strip pattern with conductive end caps 106A, 106B at each end of dipole 107A, 107B, respectively, in accordance with an embodiment of the present invention. Referring to FIG. 1B, dielectric-core transparent antenna 105 is matched and converted to a single-ended system and excited by a conventional source v_{gen}. The applied source feeding of antenna 105 can be accomplished in conventional ways, such as soldered to the conductive end caps 106A-106B at the gap, or by near-proximity capacitive coupling.

The length of the dipole antenna 105 (2l) in this geometry can be chosen to make sure that the radiating system is resonant at the design transmitting frequency. At the same time, for co-site antennas operating at a different frequency, where the antenna in FIGS. 1A-1B is non-resonant, one may apply Mie theory to find the accurate surface impedance value for the cloak required to suppress the scattering of the cloaked rod at the desired frequency. An advantage of using dielectric rods is that they exhibit naturally weak scattering for TE^{z} wavefronts thereby reducing the complexity of the cover to make them essentially fully radio-transparent. For the materials and geometries studied herein, one may consider the total scattering width (SW):

$${σ}_{2 D} = \frac{2 {λ}_{0}}{π} {\sum }_{n = 0}^{{N}_{max}} {\vert {c}_{n}^{TM} \vert}^{2} ( 2 - {δ}_{n 0} ) , \qquad ( 1 )$$

where δₙ₀ is the Kronecker delta and Nₘₐₓ is the maximum scattering order. Here cₙ^{TM} are the complex multipole scattering coefficients, with cₙ₌₀^{TM} being the omnidirectional scattering mode. This omnidirectional mode is drastically larger than the other higher order terms for moderately sized dielectric rods. Therefore, by targeting and nullifying this single mode, one may drastically reduce the overall SW in (1).

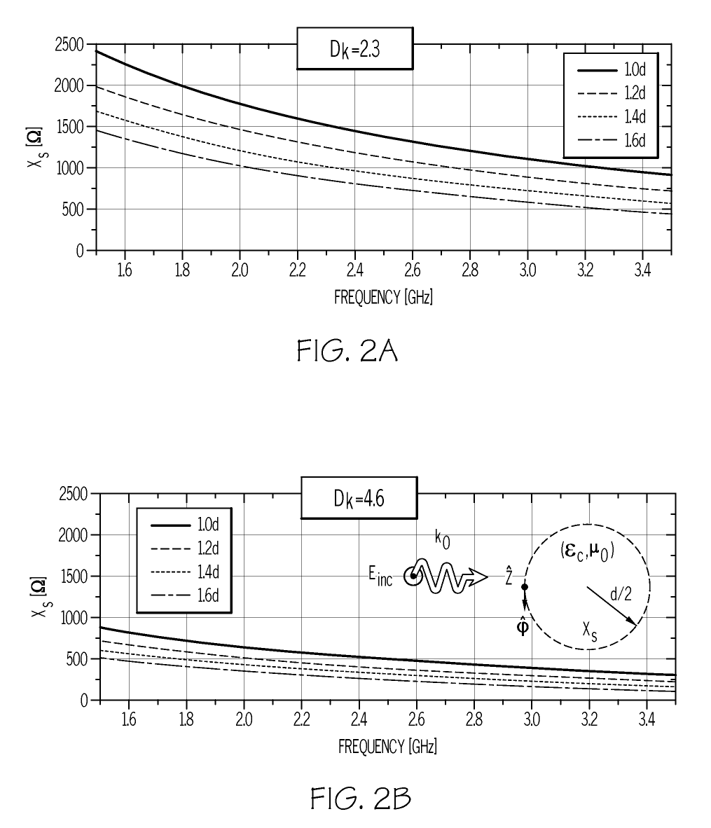

Next, consider the required surface impedance values calculated using analytical two-dimensional Mie theory in FIGS. 2A-2B. FIGS. 2A-2B illustrate the required surface impedance for dielectric rods (Dk=2.3, 4.5, respectively), where each case is compared against increasing dielectric rod diameters in accordance with an embodiment of the present invention. Referring to FIG. 2, several dielectric rod geometries are considered starting from a baseline rod diameter d₀=0.142λ₀, where f₀=2.7 GHz. Two readily available low-loss dielectric materials were chosen with Dk≡∈/∈₀=2.3, 4.5. It is noted that higher dielectrics may be chosen as well, but these are chosen based on their very low scattering characteristics and cost. As seen in FIGS. 2A-2B, the ideally lossless surface reactance X_{S} required to suppress the scattering of these rods is computed across a large communication band for the dominant TM^{z} polarized plane wave (c.f. FIGS. 1A-1B).

As it can be seen in FIGS. 2A-2B, increasingly larger surface impedances are required to reduce the scattering of dielectric cylinders as the incident wavelength becomes larger. This is expected since, in the limit of small scatterers, an open circuit is the requirement for scattering suppression. Comparing the two considered dielectric materials, it appears that Dk=4.5 leads to more realizable covers based on the required surface impedance. In the upper frequency range, the dispersion of the required surface impedance becomes “flatter” in the chosen band for larger cross-sections or higher Dk. Consequently, the suppression bandwidth at upper frequencies may be broadened using larger scattering targets, or higher permittivity values.

As an example for the cloak designs of the present invention, realizable inductive surface impedance values are considered using four thin vertical strips based on the scalar grid impedance model:

$${Z}_{S}^{TM} = j \frac{{η}_{0}}{2} \frac{{k}_{0} D}{π} ln [ csc ( \frac{π w}{2 D} ) ] ( 1 - \frac{{cos}^{2} θ}{{ɛ}_{r} + 1} ) . \qquad ( 2 )$$

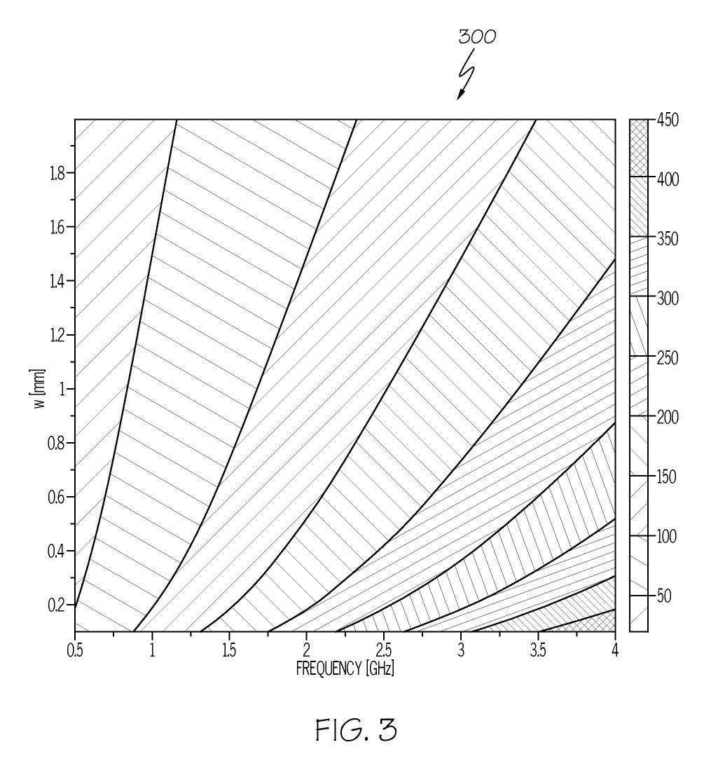

In (2), η₀, k₀ are the impedance and wave number of free-space, respectively. Here the angular dependence of the surface impedance is highlighted, where θ is measured from the cylindrical axis (\hat{z}). Considering FIG. 1A, the four vertical strips are placed with period D=πd/4, where d=1.5d₀ and the strip is swept with width w. To meet the required surface impedance X_{S}=222 and cancel the omnidirectional scattering mode at 2.7 GHz, FIG. 3 predicts w≈0.2 mm. FIG. 3 is the realized surface impedance map 300 over the band of interest for values of strip width at normal incidence in accordance with an embodiment of the present invention.

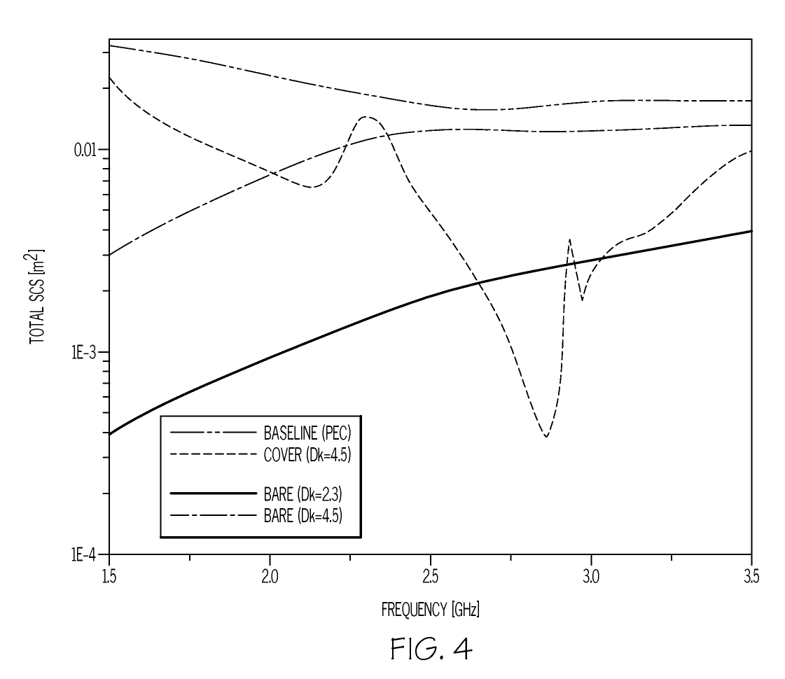

FIG. 4 shows examples of the total scattering cross-section (SCS) of a baseline perfect electric conductor (PEC), the two dielectric rods, and the covered dielectric rods with d=1.5d₀ in accordance with an embodiment of the present invention. In particular, FIG. 4 illustrates the baseline comparison of different rods of the same cross section, but with different dielectric properties in the high band of operation. An example of a covered dielectric rod of Dk=4.5 with a conformal cover is shown in FIG. 4. The high band scattering suppression is shown to be well below that of a conductive rod, and even below that of Dk=2.3 near 2.86 GHz.

Illustrated in FIG. 4, a significant reduction of the total SCS indicates a strong suppression at all viewing angles, and not just in one direction. As further illustrated in FIG. 4, the covered dipole scatters less than the baseline PEC rod of the same diameter across the entire considered band, illustrating the cloaked dielectric core antenna is much less visible than a typical antenna with the same geometry. The covered antenna scatters much less than even a low permittivity rod of Dk=2.3 near 2.86 GHz when the strip width w=0.08 mm. While the strip width is somewhat smaller than predicted in FIG. 3 and calculated from Mie theory, it is noted that the results in FIG. 4 are for a finite-length cylinder with a feeding gap, which is a more complicated geometry than the infinite (two dimensional) case considered in the analytical model of the present invention. Additionally, the grid impedance given in (2) is most accurate for dense infinite sheets, and the contours in FIG. 3 only consider normal incidence. It is important to note that the sharp scattering resonances seen in FIG. 4 are not numerical, but excitations of other scattering orders (n>0) due to the anisotropic impedance of the realistic cover over a broad bandwidth. However, it is noted that the numerical simulations in FIG. 4 consider lossless covers and dielectrics. With realistic losses, these higher-order resonances will be drastically reduced, smoothing out the much reduced scattering profile.

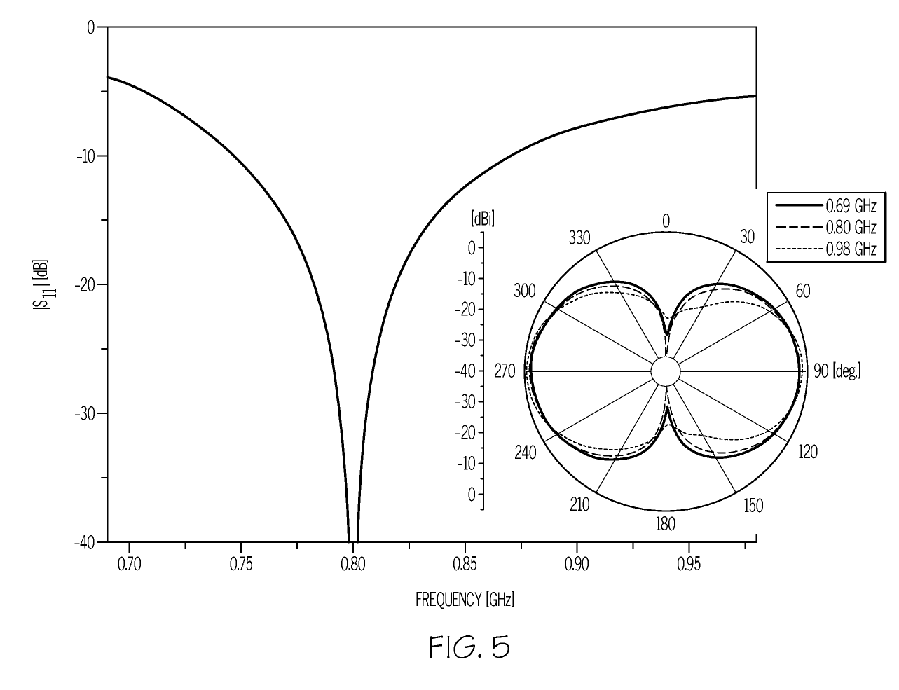

Next, how the covered dielectric-core antenna radiates when driven by the source in FIG. 1B is considered. The simulations of the present invention demonstrate in FIG. 5 that the covered antenna can be simply matched to a 50Ω source using a narrowband, single-ended L match. FIG. 5 illustrates the covered LB matching and gain for the design in FIG. 1B in accordance with an embodiment of the present invention. The matching shown in FIG. 5 is a simple narrowband L-match, but may be easily increased in bandwidth. As will be shown, a more broadband matching is possible using multiple sections or other well-known matching schemes. In the inset, the gain of the matched antenna is also plotted across a lower communication band of interest. FIG. 5 illustrates both matching and gain performance of the cloaked dielectric-core antenna, highly competitive if compared to a conventional conductor-based cylindrical dipole of similar geometry.

Circuit-Loaded Metasurface Cloaks

Previously, as discussed herein, it has been demonstrated that a moderate permittivity dielectric-core antenna can be substaneously less visible to out of band communication systems working in close proximity to it, and simultaneously work well as a radiating element with good matching and radiation patterns in a lower band. Using a slightly larger diameter (1.5d₀) dielectric core of Dk=4.5, one is able to achieve a total SCS level over 16 dB lower than that of a conducting rod with diameter d₀, and better than 8 dB lower than the bare dielectric rod of Dk=2.3 at 2.86 GHz. It has also been shown that in order to reduce the scattering of low permittivity materials high surface impedance values were needed, which may be difficult to realize with simple surfaces. Next, it is proposed to further reduce the scattering of dielectric core antennas using periodic loading of the surface using inductive lumped elements, or monolithic patterning, such as spiral inductors.

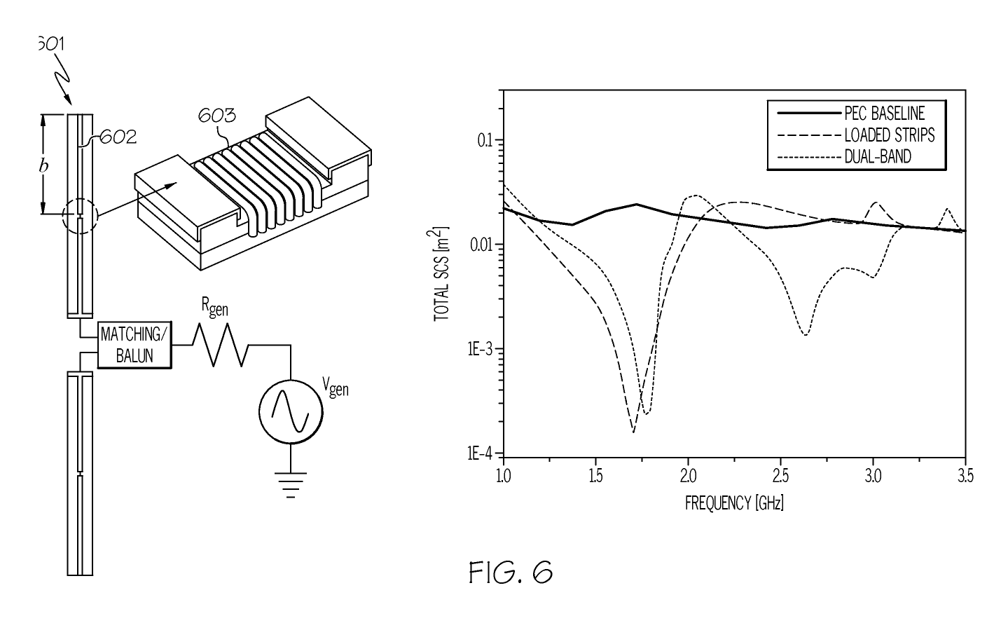

Referring now to the geometry of FIG. 6, FIG. 6 is a proposed loaded design and improved scattering reduction tuned to the low end of the communications band for single and dual-band operation in accordance with an embodiment of the present invention. In this example, a dielectric-core antenna 601 is made of diameter d₀ and uses a larger strip width of w=1 mm to accommodate the landing of a surface mount (SMT) inductor of 33 nH. To increase the effective inductive surface impedance, one may load the strips 602 with period b, in this case, half of each arm length. Using this concept, one can now increase the surface impedance at will according to:

$${Z}_{S}^{TM} = {Z}_{L} \frac{D}{b} + j \frac{{η}_{0}}{2} \frac{{k}_{0} D}{π} ln [ csc ( \frac{π w}{2 D} ) ] ( 1 - \frac{{cos}^{2} θ}{{ɛ}_{r} + 1} ) . \qquad ( 3 )$$

In (3), it is noted that the grid impedance in (2) now includes a series averaged loaded impedance Z_{L}. FIG. 6 shows the schematic of such an antenna 601, now much thinner than in previous studies. Also shown in FIG. 6, antenna 601 is tuned to the lower end of the high band at 1.7 GHz. In this case, a scattering reduction of 22 dB is seen compared to a conductive dipole of diameter d₀. One can clearly see that the large required surface reactance can be met with realizable surfaces loaded with off-the-shelf components. Also shown in FIG. 6 is the possibility of a single-layer dual-band cover. This single cover offers several degrees-of-freedom over conventional patterned mantle surfaces. The averaged surface impedance in (3) demonstrates various levels of inductance; however, in the realistic cover, the cutout landing patterns 603 for the inductors also add gap capacitances. Therefore, the first series term in (3) also has a capacitive element. Additionally, as is done in many RF designs, the parasitic elements of the realistic SMT components themselves may be exploited. Other loaded surface topologies also exist that may add additional flexibility, including loaded dipole strip surfaces:

$${Z}_{S}^{TM} = \frac{3 {a}^{2} Xin}{{l}^{2}} \frac{Xin - {jZ}_{L}}{4 {X}_{in} - {jZ}_{L}} \frac{η}{4} [ \frac{cos ( {kR}_{0} )}{k {R}_{0}} sin ( k - {R}_{0} ) ] . \qquad ( 4 )$$

Here in (4), the first term describes the characteristics of an individual electrically small dipole, where α is half the strip width of the printed dipole, 2l is again the total length of the dipole (c.f. FIGS. 1A and 1B), Xᵢₙ is the input reactance, and Z_{L} is the loading of each dipole. The second term in (4) is the interaction component an individual dipole “feels” from a surrounding homogenized current sheet of dipoles. The hole removed in this local field calculation is of radius R₀ and is very accurate for values of ka<0.5. In (4), η,k are the effective wave impedance and number, respectively, depending on the medium.

Cloaked Elliptical Antenna

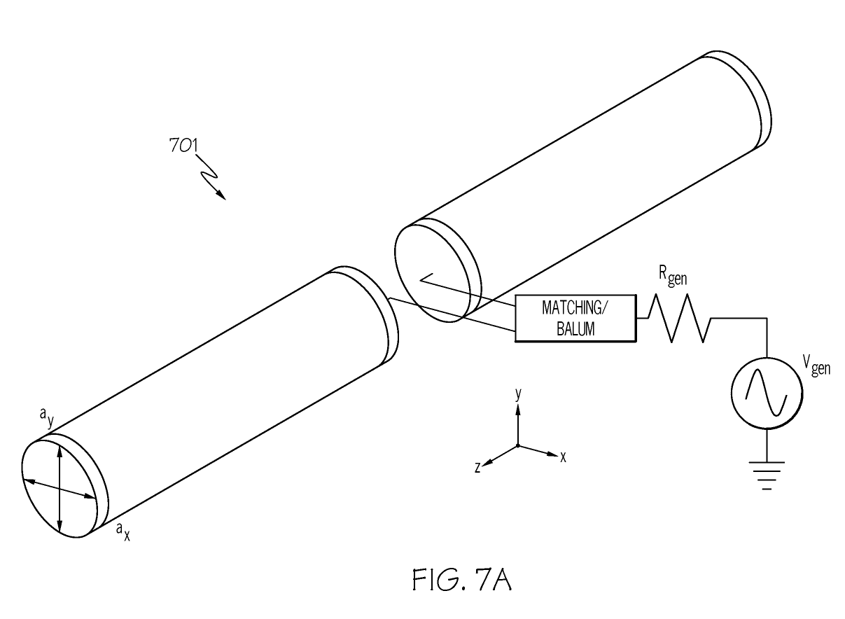

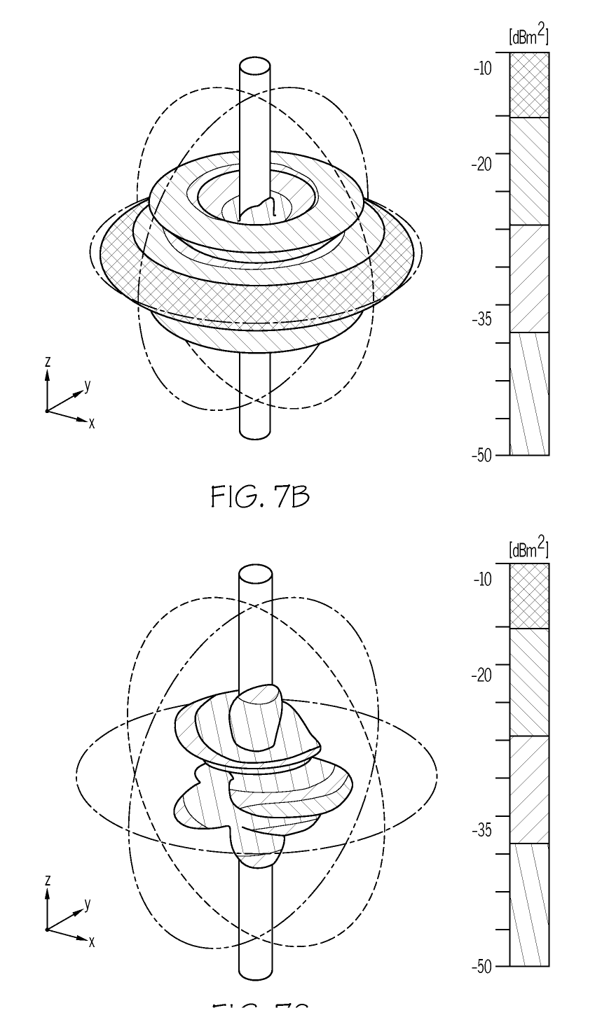

The concepts of the present invention presented herein may also be applied to elliptical cloaked dielectric-core antennas. Such elliptical geometries may be of great interest when trying to meet space requirements in high density and compact systems, or may be an additional tool for tailoring the beamwidth of the radiators. The schematic of such an antenna is shown in FIG. 7A, where FIG. 7A illustrates a schematic of an elliptical dielectric-core antenna 701 in accordance with an embodiment of the present invention. Referring to FIG. 7A, antenna 701 is now scaled where the major radius is α_{y} and the minor is αₓ. In this example, αₓ/α_{y}=0.7 and the same material and geometry is used from the design in FIGS. 1A-1B. In FIGS. 7B and 7C, FIGS. 7B and 7C illustrates the three-dimensional SCS profiles of the bare (b) and covered (c) antennas, respectively, using the decibel scale in accordance with an embodiment of the present invention. As can be seen, the scattering is still significantly reduced all around the covered elliptical antenna for a plane wave excitation of E_{inc}=\hat{z}E₀e^{j(ωt-k}^{₀}^{x)} with almost no backscattering (−\hat{x}) and a significant reduction in the forward direction as well (\hat{x}).

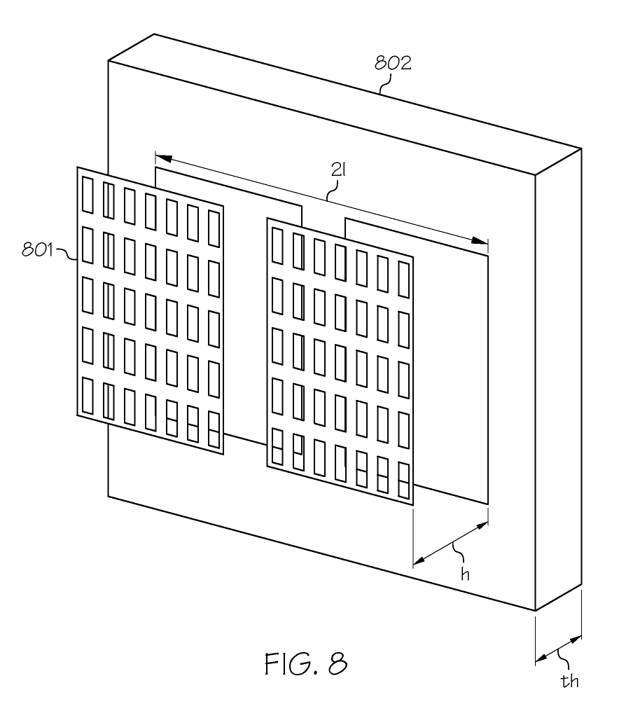

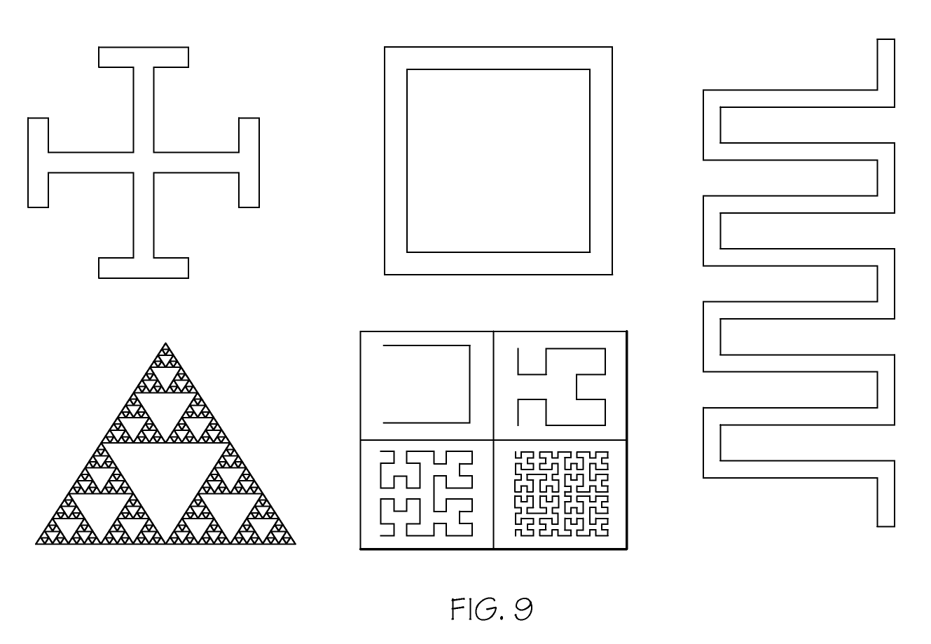

It is also envisioned that fully planar designs in the limit of these elliptical antennas are to be squeezed on a plane in a printed configuration. The original methodology may still be used to create such low scattering planar dipoles, shown schematically in FIG. 8. FIG. 8 illustrates views of a proposed planar cloaked antenna in accordance with an embodiment of the present invention. In such a case, the planar dipole 801 is printed on a dielectric substrate 802 of Dk, obviously without a ground plane. A tailored screen with various patterns, as shown in FIG. 9, where FIG. 9 illustrates various inductive traces in accordance with an embodiment of the present invention, may be applied at a distance h from the printed dipole. This pattern may be flat, as shown in FIG. 8, or conformal based on flexible substrates. The same pattern may be placed behind the printed dipole to reduce scattering in both directions. Referring to FIGS. 8 and 9, the patterned screen may be simultaneously used to reduce the scattering of the dielectric substrate 802 and be used as the antenna itself. In this proposed scenario, the planar dipole 801 could be replaced by the patterned screen for dual purposes.

The patterns discussed up to this point have an identical unit cell (i.e., patch, grid, etc.); however, they need not be. In fact, the concept of self-similarity, Hilbert curves, and tapered patterns has been demonstrated in broadband and multiband antennas, frequency selective surfaces, and high impedance surfaces. Such an approach may be used to create more broadband and multiband cloaking covers, as shown in FIG. 9.

Differential-Helix Dielectric-Rod Cloaks

FIG. 10 presents the schematic of the proposed transparent antenna 1001 cloaked with a differential helical cloak 1002, 1003 (non-intersecting helixes 1002, intersecting helixes 1003) in accordance with an embodiment of the present invention. A “differential” helix cover 1002, 1003 (double helix structure) significantly reduces the total integrated scattering from a nearby low-band antenna element. The double helix cover 1002, 1003 allows for dipolar radiation in transmit mode.

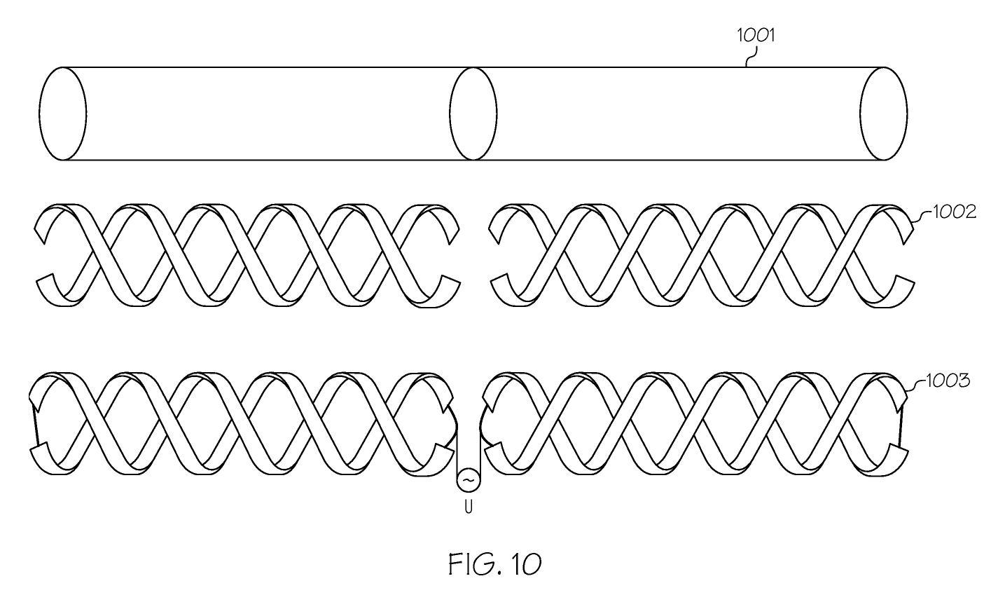

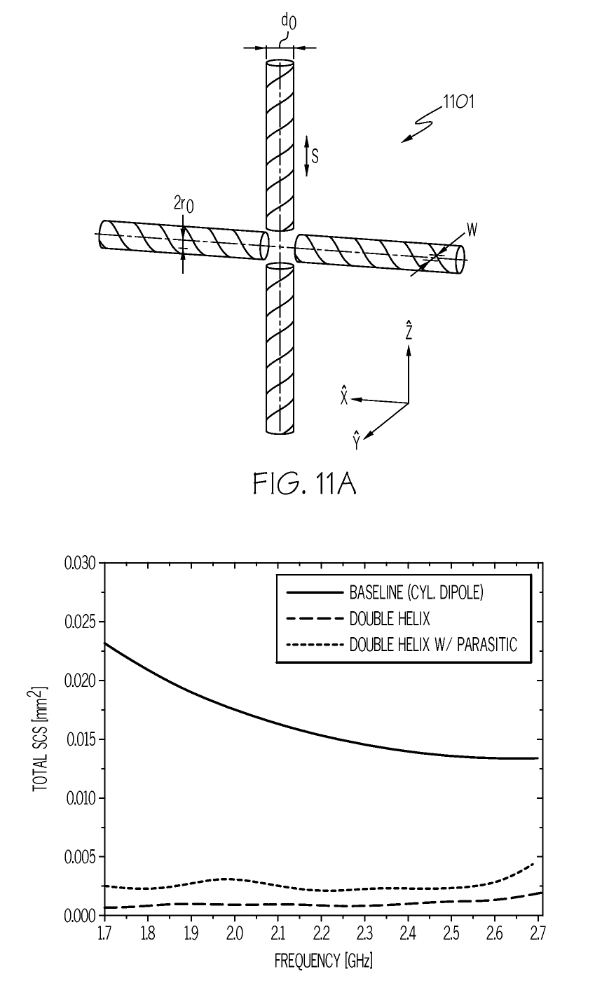

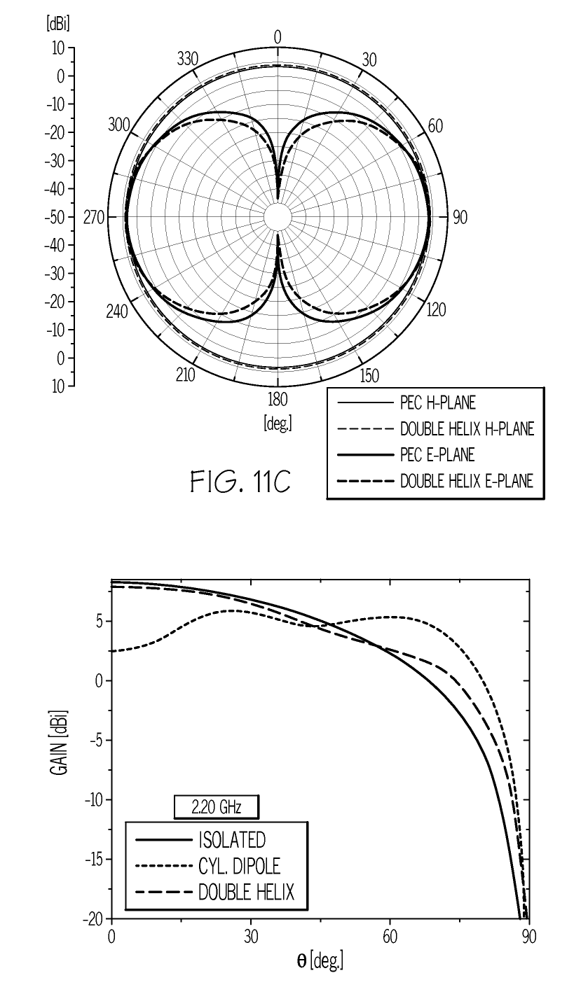

FIGS. 11A-11D show the main antenna figures of merit (FOM) for the differential cross 1101 (FIG. 11A) as both a scatterer (FIGS. 11B, 11D) and as a transmitting antenna (FIG. 11C) in accordance with an embodiment of the present invention. In particular, FIG. 11B illustrates the total SCS comparison between the baseline dipole and the single/double helix in accordance with an embodiment of the present invention. FIG. 11C illustrates the gain of the double helix dielectric-core antenna at 800 MHz in accordance with an embodiment of the present invention, as compared to a conventional conductive cylindrical dipole (PEC). FIG. 11D illustrates the gain restoration of a nearby highband element at the central frequency 2.20 GHz when place directly below the double helix with an embodiment of the present invention.

Dielectric Core Metasurface Antenna (DCMA)

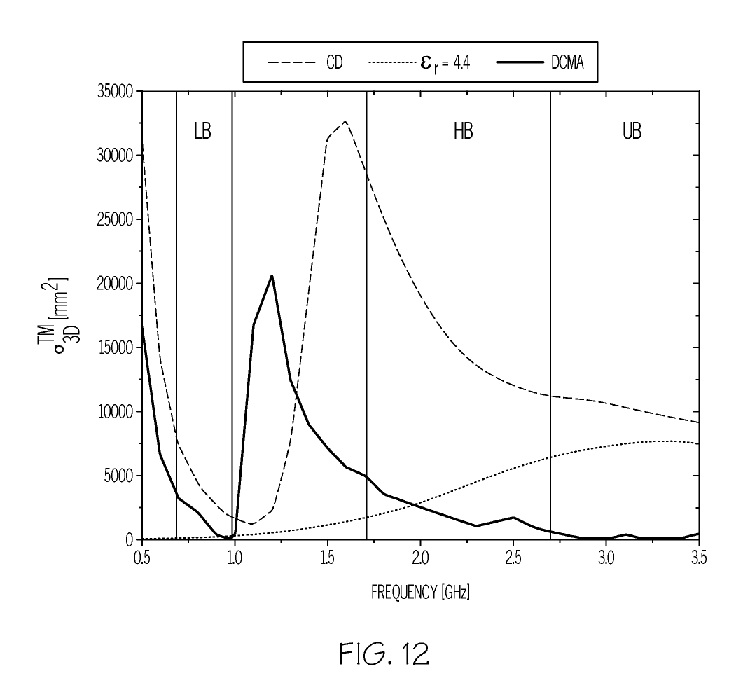

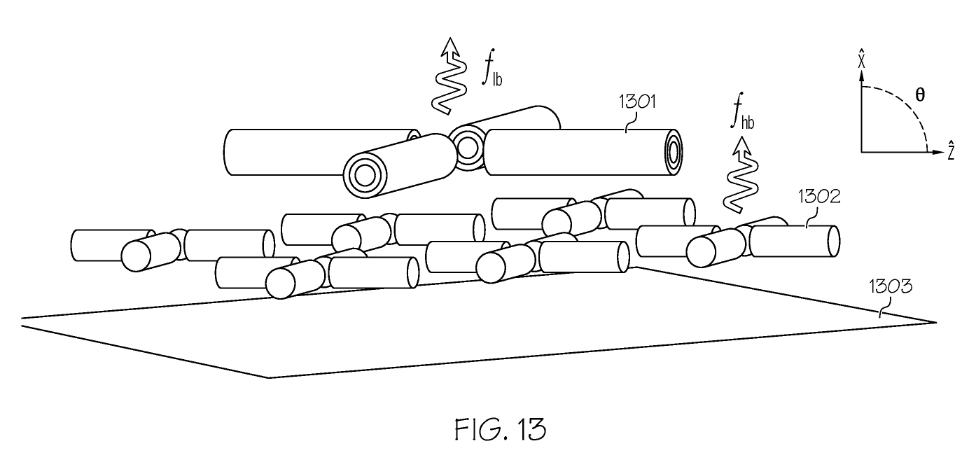

Referring to FIG. 12, FIG. 12 focuses on the operating bands for 3G and 4G LTE service providers in accordance with an embodiment of the present invention. For these specific bands, a physically larger lowband (LB) antenna (698-968 MHz) 1301 is required with the highband (HB) array (1.71-2.71 GHz) 1302 above a reflector panel 1303, as shown in FIG. 13 in accordance with an embodiment of the present invention. Proposed bands around 3.5 GHz (UB) are also highlighted here for future use as small cell or shared spectrum communications to alleviate the ever-growing wireless demands. The much larger dual polarized LB element is typically a cylindrical dipole (CD) to meet the 3 dB beamwidth (BW) and bandwidth requirements. This LB element when placed directly in front of the HB array presents a large disturbance to the HB elements, typically in terms of beam squint, which re-directs the HB radiation pattern away from its intended boresight direction (θ=90°). The BW and gain of the HB elements can also be significantly altered by the presence of this LB element. The total scattering cross-section (SCS) of the LB element, as plotted in FIG. 12, is a good measure of this electromagnetic disturbance, which intrinsically captures the LB scattering at all angles. The total SCS is plotted for the dominant axially aligned TM-polarized wavefront.

Calculated in FIG. 12, the total SCS of the CD is significant across the HB and UB, with a self-resonance around 1.5 GHz. The scattering of the bare low-loss host dielectric (without the embedded inductive screen) of ∈=∈ᵣ (1 j tan δ) is also considered, where ∈ᵣ=4.4 and tanδ=0.0005. Next by embedding a properly engineered inductive screen into this dielectric host, the SCS is significantly reduced over a large range of frequencies. As expected, even for the frequencies where the dielectric is not cloaked, the host-screen pair (DCMA) is still much lower than that of the CD, being 7.8-22.7 dB lower in the HB and UB. This dual-cloaking method is therefore conceptually very different than the typical goal of reducing the scattering of a conductive target. It is worth highlighting that to meet such bandwidths with other cloaking methods would require a very large aspect ratio (CD plus cover), which is expected to increase scattering from TE-polarized wavefronts and limit its critical elevation angle transparency, limiting their applications to simple configurations.

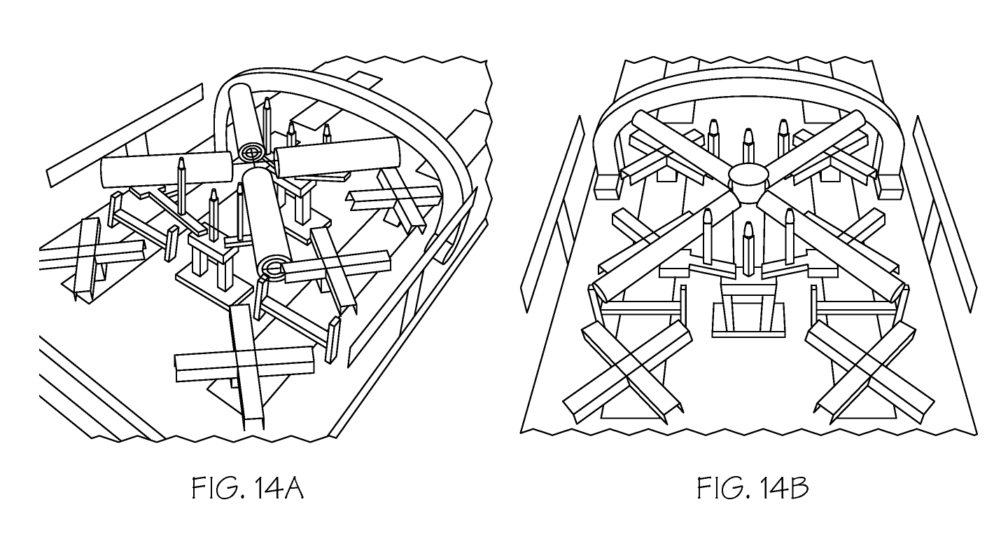

FIGS. 14A-14B show the two dual-polarized antennas above a single unit cell in accordance with an embodiment of the present invention. For testing and fabrication purposes, a simplified single 3×3 unit cell was chosen, which has non-ideal truncation effects including asymmetry and reduced ground plane effects. However, this non-ideal panel is also interesting as it demonstrates the resiliency of our method to non-ideal illumination. Here the DCMA aspect ratio (α_{DCMA}/α_{CD}) is approximately 1.4.

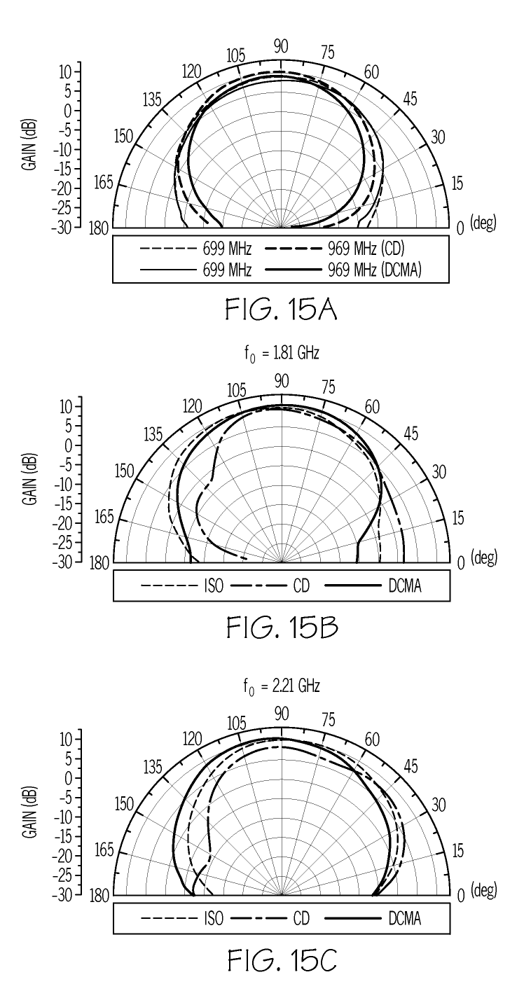

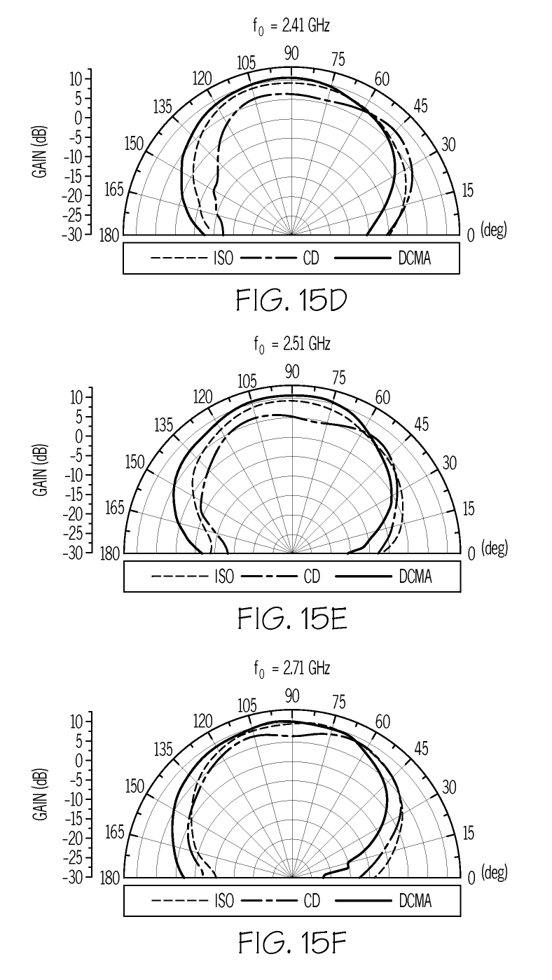

FIGS. 15A-15F capture the far-field restoration across the large operating bandwidth, where FIG. 15A compares the LB performance between the conventional CD and the DCMA, and FIG. 15B-15F are the HB panel for the isolated case, without any LB element above it in accordance with an embodiment of the present invention. FIG. 15A illustrates a very good matching between the CD and DCMA patterns. In both cases, the BW becomes slightly more narrow due to the electrical proximity of the LB elements from the reflector panel 1303. The DCMA is slightly more narrow than the CD at 969 MHz, due to the slight increase in distance from the panel than that of the CD to accommodate its slightly increased aspect ratio. Yet the comparison clearly shows good dipolar radiation from the DCMA, essentially mimicking the performance of the conventional CD.

Next in FIGS. 15B-15F, several frequencies are plotted across the HB. In all cases the DCMA closely matches that of the isolated panel radiation, especially in terms of beam squint, gain and beamwidth (BW). The CD has strong tendency to squint the HB beam, essentially re-directing the beam away from boresight. In fact at boresight, a very strong blockage is seen by the CD, reducing the HB gain by 4 dB across the band. The very low scattering of the DCMA restores the isolated HB antenna performance. Again, even the isolated patterns are non-ideal, due to the finite panel which emphasizes the potential of our method to arbitrary sources, which is based on all-angle scattering reduction for both polarizations. The HB panel radiators are dual-polarized, and the far-field patterns in FIGS. 15A-15F demonstrate this dual-polarized scattering reduction offered by the DCMA.

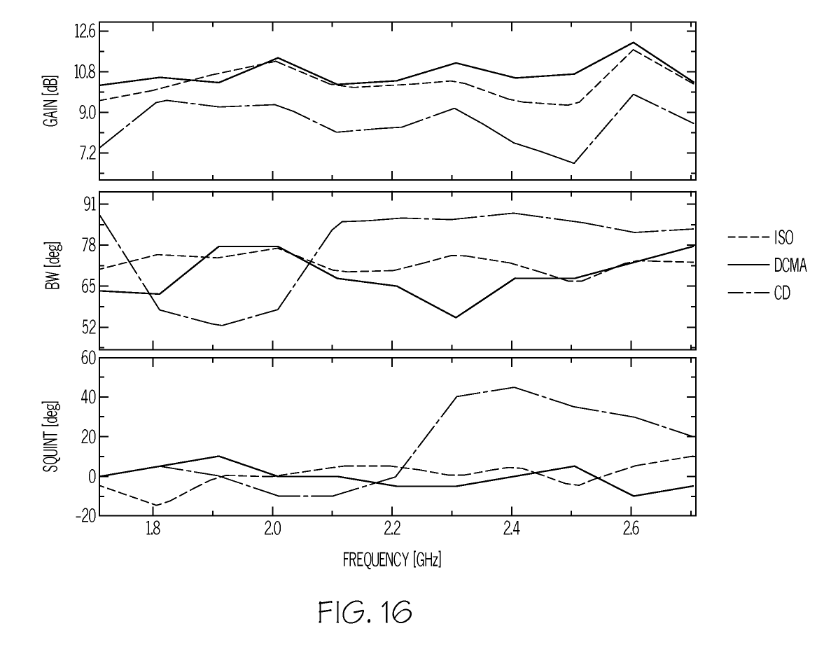

The far-field patterns in FIGS. 15A-15F demonstrate the improvements to the HB radiation patterns across a large bandwidth and angular spectra; however, in FIG. 16, FIG. 16 illustrates the gain, beamwidth and squint versus the frequency for the cases discussed in FIGS. 15A-15F in accordance with an embodiment of the present invention. That is, FIG. 16 details the improvements offered by the design method of the present invention.

Referring to FIG. 16, beam squint and 3 dB BW are the most difficult antenna metrics to restore as any nearby obstacles are unintentional parasitic reflectors to some degree. Up to 1.91 GHz, both the CD and DCMA have somewhat less effect on the pattern in terms of beam squint. However, above that, the CD shows a strong re-directing effect on the HB radiation, where the beam becomes strongly distorted. The DCMA across this mid-to-upper HB regime shows a remarkable field restoration, and across the whole band the squint is clearly lower and much more flat. It is emphasized that the CD causes a re-direction of 20-45° of the main beam between 2.310-2.710 GHz, while the DCMA is between 0°-5°, with the exception of a narrowband 10° squint at 2.610 GHz. Across the entire HB, the average beam squint caused by the CD element was measured to be 14.1°±20.5°, while the DCMA average was −0.45°±5.7°. For comparison, the measured average beam squint of the isolated panel was 0.45°±6.8°. It is also interesting to compare the measured beam squint to the total SCS calculated in FIG. 12, where one can clearly see the suppression bandwidth and the narrowband scattering peaks of the DCMA. Below 2.0 GHz, the total SCS of the DCMA increases and a narrowband peak is noticed around 2.6 GHz. This peak is related to the angular stability of the design of the present invention, which was minimized by using a simple inductive strip screen and is confirmed in the far-field measurements. The antenna gain and BW are next considered, where the CD introduces strong BW instability across the band with a reduced gain. The average gain in the presence of the LB CD was measured to be 8.6±1.9 dB. Meanwhile, the DCMA gain average was 11.9±2.5 dB, and the average measured gain of the isolated case was 10.1±2.9 dB. The average measured BW for the CD was 77.4°+14.0°, DCMA was 68.5°±7.2°, and the isolated case was 72.2°±3.1°. When considering the gain and BW, it is important to consider they are measured at the maximum beam angle. Therefore, one must consider that the DCMA and isolated cases are measured nearly at boresight, while the CD metrics are significantly skewed from by the beam squint they introduce. By comparing these performance metrics holistically, the field restoration of the DCMA design is impressive.

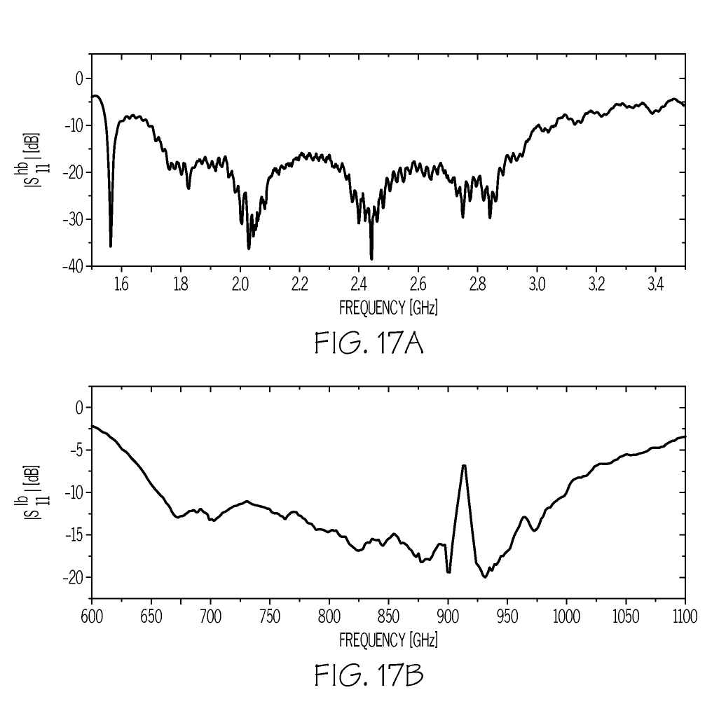

FIG. 17A illustrates the matching of the HB elements with DCMA placed above them in accordance with an embodiment of the present invention. This demonstrates that the proposed DCMA antenna has very little effect on the matching of the HB elements. FIG. 17B illustrates the wideband matching of the DCMA antenna in the LB frequencies in accordance with an embodiment of the present invention.

As discussed herein, several ideas have been introduced to significantly reduce the electromagnetic presence of antennas while still maintaining good radiation and matching properties. Several realistic designs have been shown which are simple and cheap to build. Loaded mantle metascreens, elliptical and planar antennas, and self-similar patterns have also been discussed. A differential double helix cover has been introduced, which shows very good suppression and bandwidth, and can radiate well in dipole antenna applications. These new techniques offer a new set of tools and design methodologies for radio-transparent transmitting antennas to enable high-density communication platforms with low coupling and interference. Finally, the methods of the present invention discussed herein are used to realize a DCMA, which demonstrate the potential of such antennas.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An antenna, comprising:
a dielectric core covered by a patterned conductive cover, wherein an impedance of said patterned conductive cover is selected to reduce a scattering of said dielectric core at desired frequencies or over a desired frequency range.

2. The antenna as recited in claim 1, wherein said dielectric core comprises a dielectric rod.

3. The antenna as recited in claim 1, wherein said impedance of said patterned conductive cover is accomplished via vertical strips.

4. The antenna as recited in claim 1, wherein said patterned conductive cover comprises inductive lumped elements or monolithic patterns.

5. The antenna as recited in claim 4, wherein said monolithic patterns comprise spiral inductors.

6. The antenna as recited in claim 4, wherein said patterned conductive cover is a single-layer dual-band cover.

7. The antenna as recited in claim 1, wherein said dielectric core is elliptical shaped.

8. The antenna as recited in claim 1, wherein said dielectric core comprises a planar dipole printed on a dielectric substrate.

9. The antenna as recited in claim 8, wherein a screen with a selected pattern is applied at a distance from said printed dipole.

10. The antenna as recited in claim 9, wherein said selected pattern is flat.

11. The antenna as recited in claim 9, wherein said selected pattern is curved.

12. The antenna as recited in claim 9, wherein said selected pattern comprises an identical unit cell.

13. The antenna as recited in claim 9, wherein said selected pattern comprises a Hilbert curve or a tapered pattern.

14. The antenna as recited in claim 1, wherein said patterned conductive cover comprises a double helix structure thereby allowing for dipolar radiation in transmit mode.

15. The antenna as recited in claim 1, wherein said patterned conductive cover comprises a single helical structure.

16. The antenna as recited in claim 1, wherein said patterned conductive cover comprises a patterned metallic cover.
